(19) United States
(12) Patent Application Publication
(10) Pub. No.: US 2026/0238575 A1
(43) Pub. Date: Aug. 13, 2026

(54) CLOUD RADIO ACCESS NETWORK ACCELERATION LATENCY OPTIMIZER

(71) Applicant: Telefonaktiebolaget LM Ericsson (publ), Stockholm (SE)

(72) Inventors: Edgard FIALLOS, Solna (SE); Johan EKER, Lund (SE)

(73) Assignee: Telefonaktiebolaget LM Ericsson (publ), Stockholm (SE)

(21) Appl. No.: 19/161,224

(22) PCT Filed: Mar. 15, 2023
(86) PCT No.: PCT/SE2023/050228

§ 371 Date: Aug. 29, 2025

(51) Int. Cl. H04L 43/0852; H04L 41/40; H04L 47/70; H04W 72/0446

(52) U.S. Cl. CPC H04L 43/0852; H04L 41/40; H04L 47/826; H04W 72/0446

(57) ABSTRACT

A method and apparatus for receiving information on arriving data packets and analyzing the data packets to determine processing latency for processing the data packets. When the processing latency for processing the data packets by a central processing unit (CPU) is below a processing latency threshold, assigning allocation of the data packets to the CPU for processing the data packets. When the processing latency for processing the data packets by the CPU is above the processing latency threshold, assigning the allocation of the data packets to an accelerator processor for processing the data packets

### TECHNICAL FIELD

Embodiments of the disclosure relate to the field of communications; and more specifically, to an optimizer for efficient scheduling of an accelerator to improve latency in a cloud radio access network.

### BACKGROUND ART

The 3rd Generation Partnership Project (3GPP) unites a number of telecommunications standard developments, of which the 5th Generation (5G) communications technology is the newest. The 5G communications systems employ a new 5G core (5GC) and new radio access technology referred to as New Radio (NR). As part of the 5G deployment, many of the operations previously provided by dedicated hardware are now processed by virtual machines and virtual functions in a cloud environment.

Cloud technology has swiftly transformed the Information and Communications Technology (ICT) industry and is continuing to spread to new areas. Many traditional ICT applications are suitable for cloud deployment in that they have relaxed timing or performance requirements, but that is not necessarily true for several novel service categories. Cloud systems are usually built on top of large scale commodity servers (e.g., x86 based systems). In order to take the cloud concepts beyond the ICT domain and apply it to more mission critical use cases (such as telecom, industrial automation, and real-time analytics), different kinds of accelerators and new software scheduling techniques are needed.

The Internet Engineering Tak Force (IETF) Network Function Virtualization (NFV) initiative is standardising a virtual networking infrastructure and a Virtual Network Function (VNF) architecture. The attention is currently at the higher layers in the network stack (e.g., virtual Internet Protocol (IP) Multimedia Subsystem (IMS); virtual Evolved Packet Core (vEPC); virtual Mobility Management Entity (vMME); etc.)

However, the possibilities for doing L1 & L2 processing in a virtualized environment is currently being explored. While commodity servers are becoming increasingly powerful, they still fall short for certain tasks compared to the current base station processing platforms. The trade-off is on efficiency of computations versus lowered capital expenditure when using Commercial Off-The-Shelf (COTS) hardware. To be able to obtain reasonable performance from COTS hardware, the software architecture and resource scheduling needs to be carefully designed. The COTS hardware requires augmentation with accelerators, such as Graphics Processing Units (GPUs); Field-Programmable Gate Arrays (FPGAs); Application-Specific Integrated Circuits (ASICs); etc. These accelerators are typically challenging to share efficiently in multi-user/multi-tenant/multi-service setting, since they lack support for pre-empting jobs and resuming them, which are available on standard or general purpose Central Processing Units (CPUs).

For baseband processing in a wireless communication network that utilizes a cloud Radio Access Network (RAN), the system generally requires some sort of accelerator hardware to support high throughput. However, such accelerators come with a minimum latency cost which are independent of payload size.

### SUMMARY

Certain aspects of the present disclosure and their embodiments provide solutions to challenges noted above. In one aspect of the disclosed system, a method provides for optimizing processing of data packets based on latency by: receiving information on arriving data packets; analyzing the information on arriving data packets to classify the data packets to determine processing latency for processing the data packets by a central processing unit (CPU); when the processing latency for processing the data packets by the CPU is below a processing latency threshold, assigning allocation of the data packets to the CPU for processing the data packets; and when the processing latency for processing the data packets by the CPU is above the processing latency threshold, assigning the allocation of the data packets to an accelerator processor for processing the data packets.

In another aspect of the disclosed system, the analyzing the information on the arriving data packets comprises analyzing a number or size of the data packets.

In another aspect of the disclosed system, the processing latency threshold is determined at a point where an estimated latency for processing the data packets at the CPU approximately equals an estimated latency for processing the data packets by sending the data packets to the accelerator processor.

In another aspect of the disclosed system, the method further includes acquiring information to determine latency times for respective different number or size of data packets for processing by the CPU and for processing when sent to the accelerator processor; and comparing the latency times for processing by the CPU and processing when sent to the accelerator processor to determine an approximate intersection point where the latency times for the CPU and the latency times for the accelerator processor are equal to set the processing latency threshold.

In another aspect of the disclosed system, the method further includes obtaining feedback on latency times of the respective different number or size of data packets to adjust the processing latency threshold.

In another aspect of the disclosed system, the analyzing the information on the arriving data packets further comprises analyzing a type of data packet to determine whether the data packets is of a selected type to be subjected to determine the processing latency for processing the data packets.

In another aspect of the disclosed system, the analyzing the information on the arriving data packets is performed at a Layer 2 level.

In another aspect of the disclosed system, the analyzing the information on the arriving data packets is performed for a Transmission Time Interval based on a number of Code Blocks at the Layer 2 level.

In another aspect of the disclosed system, data packet output of the CPU and data packet output of the accelerator processor are processed at a Layer 1 level.

In another aspect of the disclosed system, the analyzing the information on the arriving data packets is performed at a virtual Distributed Unit (vDU) of a baseband node of a wireless communications network, in which at least the accelerator processor is deployed as a Virtual Network Function separate from the CPU.

In another aspect of the disclosed system, the vDU is a virtual node in a cloud Radio Access Network or Open-Radio Access Network of the wireless communications network.

In another aspect of the disclosed system, a network node provides for optimizing processing of data packets based on latency, in which the network node is configured to: receive information on arriving data packets; analyze the information on arriving data packets to classify the data packets to determine processing latency to process the data packets by a central processing unit (CPU); when the processing latency for processing the data packets by the CPU is below a processing latency threshold, assign allocation of the data packets to the CPU to process the data packets; and when the processing latency to process the data packets by the CPU is above the processing latency threshold, assign the allocation of the data packets to an accelerator processor to process the data packets.

In another aspect of the disclosed system, to analyze the information on the arriving data packets comprises analysis of a number or size of the data packets.

In another aspect of the disclosed system, the processing latency threshold is determined at a point where an estimated latency to process the data packets at the CPU approximately equals an estimated latency to process the data packets when sending the data packets to the accelerator processor.

In another aspect of the disclosed system, the network node is further configured to acquire information to determine latency times for respective different number or size of data packets to process by the CPU and to process when sent to the accelerator processor; and compare the latency times to process by the CPU and to process when sent to the accelerator processor to determine an approximate intersection point where the latency times for the CPU and the latency times for the accelerator processor are equal to set the processing latency threshold.

In another aspect of the disclosed system, the network node is further configured to obtain feedback on latency times of the respective different number or size of data packets to adjust the processing latency threshold.

In another aspect of the disclosed system, to analyze the information on the arriving data packets further comprises to analyze a type of data packet to determine whether the data packets is of a selected type to be subjected to determine the processing latency to process the data packets.

In another aspect of the disclosed system, to analyze the information on the arriving data packets is performed at a Layer 2 level.

In another aspect of the disclosed system, to analyze the information on the arriving data packets is performed for a Transmission Time Interval based on a number of Code Blocks at the Layer 2 level.

In another aspect of the disclosed system, data packet output of the CPU and data packet output of the accelerator processor are processed at a Layer 1 level.

In another aspect of the disclosed system, the network node is a virtual Distributed Unit (vDU) of a baseband node of a wireless communications network, in which at least the accelerator processor is deployed as a Virtual Network Function separate from the CPU.

In another aspect of the disclosed system, the network node operates in a cloud Radio Access Network or Open-Radio Access Network of the wireless communications network.

In another aspect of the disclosed system, a computer program containing instructions which, when executed on at least one processor, cause the at least one processor to carry out a method that provides for optimizing processing of data packets based on latency by: receiving information on arriving data packets; analyzing the information on arriving data packets to classify the data packets to determine processing latency for processing the data packets by a central processing unit (CPU); when the processing latency for processing the data packets by the CPU is below a processing latency threshold, assigning allocation of the data packets to the CPU for processing the data packets; and when the processing latency for processing the data packets by the CPU is above the processing latency threshold, assigning the allocation of the data packets to an accelerator processor for processing the data packets.

In another aspect of the disclosed system, a computer-readable storage medium has stored thereon a computer program which provides for carrying out a method for optimizing processing of data packets based on latency by: receiving information on arriving data packets; analyzing the information on arriving data packets to classify the data packets to determine processing latency for processing the data packets by a central processing unit (CPU); when the processing latency for processing the data packets by the CPU is below a processing latency threshold, assigning allocation of the data packets to the CPU for processing the data packets; and when the processing latency for processing the data packets by the CPU is above the processing latency threshold, assigning the allocation of the data packets to an accelerator processor for processing the data packets.

There are, proposed herein, various embodiments which address one or more of the issues disclosed herein. Certain embodiments may provide one or more of the following technical advantages.

A solution disclosed herein uses Media Access Control (MAC) layer transport block (TB) classification to optimize latency for hardware accelerated cloud Radio Access Network (RAN) deployments.

A solution disclosed herein improves the latency of transmission and reception of small Layer 1 (L1) payloads without sacrificing the high throughput derived from the use of an accelerator, such as GPUs, FPGAs, ASICs, or other external acceleration for data processing.

### BRIEF DESCRIPTION OF THE DRAWINGS

The embodiments of the disclosure may best be understood by referring to the following description and accompanying drawings.

FIG. 1 shows a high-level view of a processing pipeline for a communications system and highlighting a distributed unit as a baseband node within the communications system in accordance with some embodiments of the present disclosure.

FIG. 2 shows a latency diagram using an accelerator for the baseband node of FIG. 1 in accordance with some embodiments of the present disclosure.

FIG. 3 shows a block diagram of an optimizer employed to improve processing latency in accordance with some embodiments of the present disclosure.

FIG. 4 shows a diagram of latency versus payload size for both a CPU and with an accelerator in accordance with some embodiments of the present disclosure.

FIG. 5 shows a flow diagram for a method performed by an optimizer to improve processing latency in accordance with some embodiments of the present disclosure.

FIG. 6 shows a network node containing an optimizer to improve processing latency in accordance with some embodiments of the present disclosure.

FIG. 7 shows a network node containing an optimizer to improve processing latency in accordance with some embodiments of the present disclosure.

FIG. 8 shows an implementation example for a cloud RAN in accordance with some embodiments of the present disclosure.

FIG. 9 shows an implementation example for an Open RAN in accordance with some embodiments of the present disclosure.

### DETAILED DESCRIPTION

The following description describes methods and apparatus for cloud Radio Access Network (RAN) acceleration latency optimizer. However, the technique can be applied to other than cloud RAN. The technique can be applied to various systems that employ accelerated processing by use of accelerators that operate externally to a main processor (such as a CPU) that controls the data being sent to the accelerator. The following description describes numerous specific details such as operative steps, resource implementations, data structures, types of data, types of network functions, and interrelationships of system components of a wireless network to provide a more thorough understanding of the present disclosure. It will be appreciated, however, by one skilled in the art that the embodiments of the present disclosure can be practiced without such specific details. In other instances, control structures, circuits, memory structures, system and/or network functions, and software instruction sequences have not been shown in detail in order not to obscure the present disclosure. Those of ordinary skill in the art, with the included descriptions, will be able to implement appropriate functionality without undue experimentation.

References in the specification to “one embodiment,” “an embodiment,” “an example embodiment,” “some embodiments,” etc., indicate that the embodiment described may include a particular feature, structure, or characteristic, but every embodiment may not necessarily include the particular feature, structure, or characteristic. Moreover, such phrases do not necessarily refer to the same embodiment. Furthermore, when a particular feature, structure, model, or characteristic is described in connection with an embodiment, it is submitted that it is within the knowledge of one skilled in the art to implement such feature, structure, characteristic, or model in connection with other embodiments whether or not explicitly described.

Bracketed text and blocks with dashed borders (e.g., large dashes, small dashes, dot-dash, and dots) may be used herein to illustrate optional operations that add additional features to embodiments of the present disclosure. However, such notation should not be taken to mean that these are the only options or optional operations, and/or that blocks with solid borders are not optional in some embodiments of the present disclosure.

Some of the embodiments contemplated herein will now be described more fully with reference to the accompanying drawings. Other embodiments, however, are contained within the scope of the subject matter disclosed herein. The disclosed subject matter should not be construed as limited to only the embodiments set forth herein; rather, these embodiments are provided by way of example to convey the scope of the subject matter to those skilled in the art.

Some of the embodiments contemplated herein apply to specific functions, data structures, network node, etc., associated with 3GPP communication technologies. However, embodiments of the disclosed latency optimizer can be deployed in other than communication systems. The latency optimizer can be implemented where external accelerators are available for use, especially where the accelerator is deployed in a cloud environment.

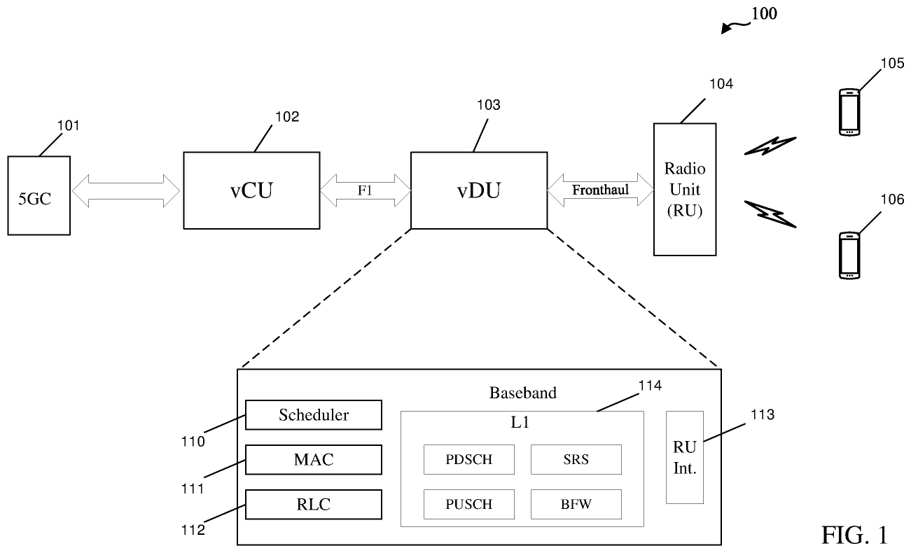

FIG. 1 shows a high-level view of a processing pipeline for a communications system 100 and highlighting a distributed unit as a baseband node within the communications system 100. The communications system 100 shown is a 5G communications system; however, communications system 100 may be of other 3GPP generation communications systems that employ cloud technology. The communications system 100 includes a 5G Core (5GC) 101 that communicates with a baseband portion that is implemented in a cloud environment. The baseband portion includes a virtual central unit (vCU) 102 and a virtual distributed unit (vDU) 103. The communications system 100 also includes a radio unit (RU) 104, which provides the radio access network that wirelessly communicates with various wireless terminals. A variety of devices and/or user connections can be connected to RU 104. Such devices can be a variety of terminal devices, commonly referred to as user equipment (UE). The devices can include, but are not limited to, computers, laptops, set-top boxes, televisions, mobile devices, wireless devices, machine type device, Internet of Things (IOT) devices, etc. These terminal devices provide services in the areas of data transfer, including Enhanced Mobile Broadband (eMBB), Machine Type Communications (MTC), Massive MTC (MMTC) and Ultra Reliable Low Latency Communications (URLLC), IoT, Massive IoT, and Critical IoT, as well as voice and streaming data. In the example, two wireless terminal devices, shown as UE 105 and UE 106, connect to the RU 104.

The vCU 102 communicates with the 5GC 101 to provide higher layer functions for both the control plane (CP) and user plane (UP). The vCU 102 communicates with the vDU 103 via an F1 interface. The vDU 103 provides lower layer functions for baseband processing of signals and may also provide a portion of physical (PHY) layer functions. The vDU 103 communicates with the RU 104, which provides the air interface to communicate with wireless terminals, such as UE 105 and UE 106. In some cases the vCU 102 and vDU 103 may operate in non-virtual environments. However, for the example shown, both vCU 102 and vDU 103 operate in a virtual environment, sometimes referred to as cloud RAN.

The vDU 103 includes a scheduler 110, media access control (MAC) unit 111, radio link control (RLC) unit 112, RU interface 113 and Layer 1 (L1) unit 114. Some of the traffic operated on at the L1 level are shown, which are Physical Downlink Shared Channel (PDSCH), Physical Uplink Shared Channel (PUSCH), Sounding Reference Signal (SRS), and BeamForming Weight (BFW) calculation. These signals are provided as an example only.

Although not shown, other signals may be operated on at the L1 level as well. These signals at the L1 level are candidates for processing using external accelerators.

The 5G Cloud RAN deployments require a significant hardware acceleration, such as by use of a GPU. While the significant processing power given by external CPU acceleration can yield increases in air interface throughput, it can impose an unnecessary latency penalty on a certain type of UE traffic. FIG. 1 provides an overview of the processing pipeline. The communication system 100 depicts packet traffic coming from a core node (such as the 5GC 101) and processed by the vCU 102 and vDU 103 before being transferred to the RU 104 for transmission to the UEs 105, 106. And in reverse, vDU 103 and vCU 102 process packet traffic received from the UEs 105, 106 for transfer to the 5GC 101. Parts of the baseband processing in the vDU 103 may require hardware acceleration. The processing is done as periodic tasks and the execution-time is driven by many factors but most notably the amount of data to be transmitted. Actual execution-time typically varies depending on the type and model of the accelerator. With cloud implementation employing Network Function Virtualization (NFV), a Virtual Network Function (VNF) such as vDU 103 could deploy different accelerators with each instance. Thus, accelerator characteristics and performance may vary significantly depending on the assigned resources.

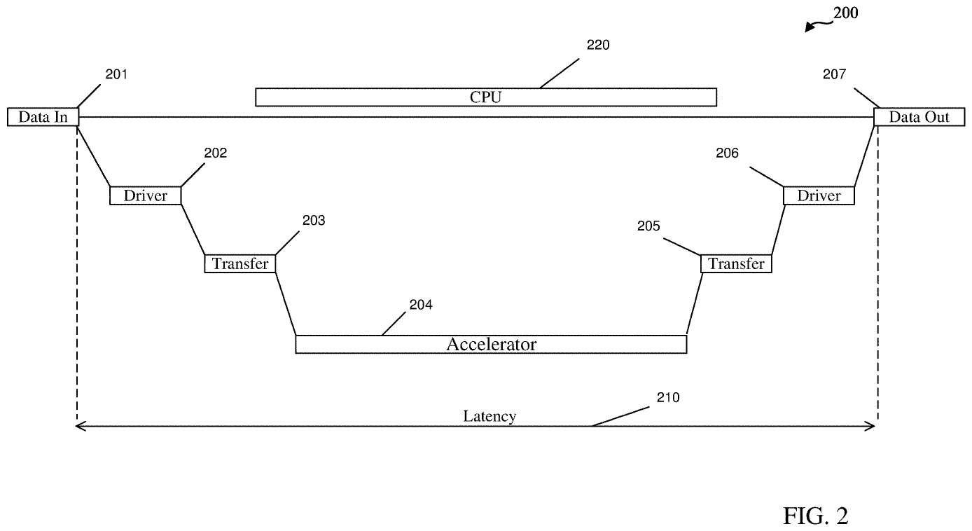

Furthermore, external CPU acceleration such as a GPU, FPGA, EMCA, etc., can provide a significant reduction in compute time due to their highly parallelized architecture. However, the interface framework associated with such systems has been optimized for throughput, not latency. A key characteristic of such interfaces is that these accelerators do not offer coherent memory mapping, hence issuing a work requires a certain amount of driver overhead setup and communication overhead (e.g., Peripheral Component Interconnect express (PCIe) latency), which is independent of the size of the payload. A sequence of events is outlined in FIG. 2, which shows that in cases where the processing time at the accelerator is short (e.g., for very small data packages) the overhead can become substantial if the payload is sent to an accelerator.

FIG. 2 shows a latency diagram 200 using an accelerator for the baseband node of FIG. 1 in accordance with some embodiments of the present disclosure. A common strategy to compensate for such overhead is to pool the processing of L1 packets into one workload to amortize the latency cost over many UE transmissions. This means that on average, L1 acceleration can significantly reduce the L1 latency (compared to CPU core processing). This technique improves the latency of very large spectrum allocation at the expense of those UEs requiring small payloads.

A typical operation of an accelerator processing requires “overhead” time in addition to the time required for processing the data. In the example illustration, diagram 200 shows the overhead time for an input data 201 as the time needed to set the driver 202 as well as the time it takes to make the transfer 203. Once the accelerator 204 performs the processing, the return transfer 205 and driver 206 overhead times are encountered to output the data 207. Thus, latency 210 depicts an approximation of the total latency from the point of commencement of data transfer to the accelerator, followed by the processing of the data at the accelerator, and return of the processed data.

Assuming that the latency 210 is the minimum latency encountered for packets sent to the accelerator 204 for processing, including the overhead time, there are instances in which smaller packets could be processed at the local level. The local processor, such as a central processing unit (CPU) can process smaller size packets with a latency 220 shorter than latency 210. Accordingly, some embodiments described in this disclosure utilize an optimizer to select packets for either the local processor (e.g., CPU) processing or accelerator processing based on estimated latency of the CPU versus the accelerator.

A solution disclosed herein for some embodiments is based on classifying LI data packets based on their number or size. In some instances, other latency or throughput properties due to traffic type (e.g., URLLC), traffic priority, and/or network slice requirements can be considered as well. One such classification can take place on a Transmission Time Interval (TTI) based on the number of Code Blocks (CBs) to be transmitted or received over the air. Some embodiments can use other classifications of data instead of TTI and CB. This information is found in the MAC scheduler, so it is possible to take advantage of this knowledge to determine which scheduling entities benefit from external acceleration, and which ones are small enough to be processed by the CPU. This technique results in creating two data flows, one that consists of very small payloads that can be easily sent to the radio with low latency, while large spectrum allocations can be aggregated and sent to the external accelerator over a second path.

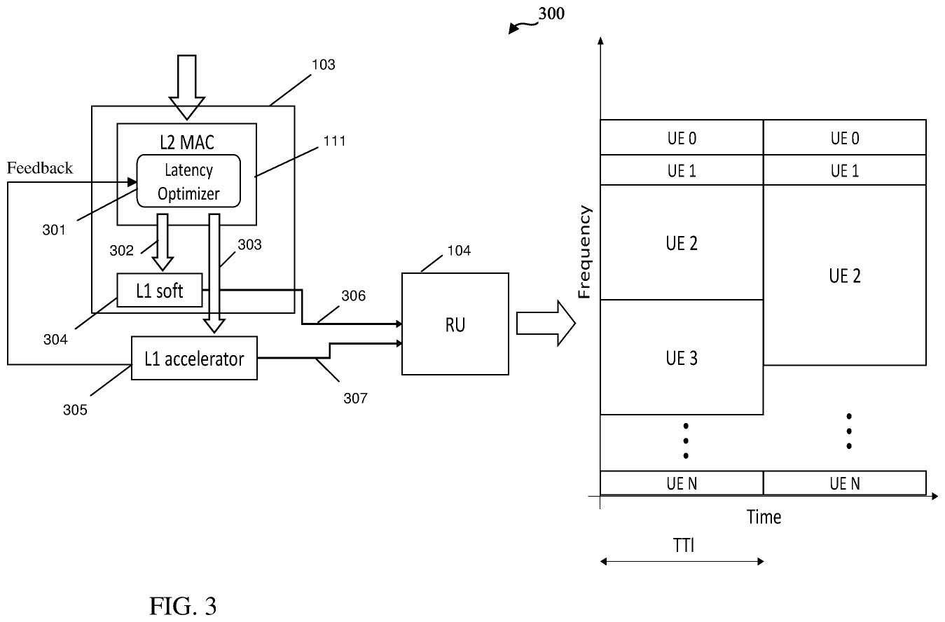

FIG. 3 shows a block diagram of an optimizer employed to improve processing latency in accordance with some embodiments of the present disclosure. FIG. 3 shows a system 300, which is equivalent to system 100 of FIG. 1, but with the added inclusion of a latency optimizer 301 with two associated paths 302 and 303. The latency optimizer 301 is shown located with MAC unit 111, however, in some embodiments the latency optimizer 301 can be located elsewhere. In some instances, the latency optimizer 301 can be located in a network node other than the vDU 103. A function of the latency optimizer 301 is to obtain information about the packet traffic (hereinafter referred to as data packets) in order to classify the data packets for analysis as to which one of the processing paths 302 or 303 to take for processing the data packets.

As data packets are received at vDU 103 in either direction (5GC-to-UE or UE-to-5GC), the latency optimizer 301 receives information on the arriving data packets. Note that FIG. 3 shows data packet flow from 5GC to the UEs, however, the latency optimizer 301 can operate in a similar manner for the data packet flow from the UEs to the 5GC. The received information on the arriving data packets can take many forms. The purpose of the information is to classify the data packets for latency analysis as to which of the two paths 302, 303 to take for packet processing. The path 302 allocates the data packets to CPU 304. The path 303 allocates the data packets to the accelerator processor 305. The information on data packets is generally available and found in the L2 MAC 111. A part of the analysis is to classify the data packets and analyze the number or size of the data packets. In some embodiments, the latency optimizer 301 can also obtain information on other latency sensitive properties as well.

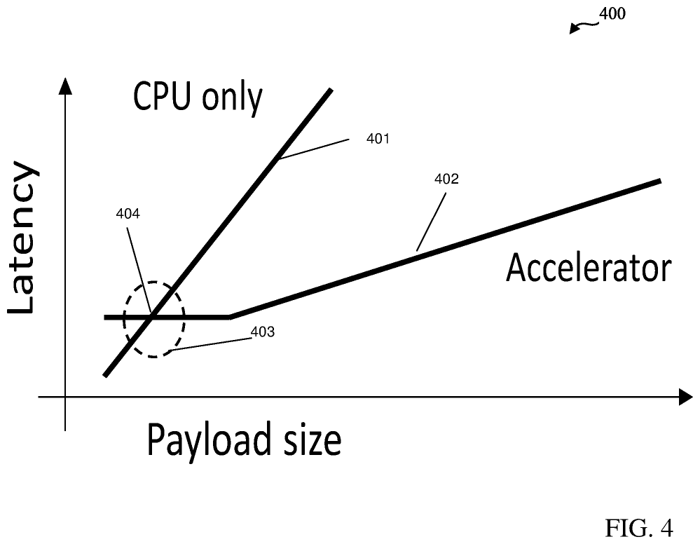

Although various information can be obtained for latency analysis, in some embodiments the latency optimizer 301 looks at a Transmission Time Interval (TTI) based on the number of Code Blocks (CBs) to be transmitted or received over the air. Some embodiments can look at other time intervals and/or use other size classification of data instead of TTI and CB. Once the latency optimizer 301 obtains the information on the data packets, the latency optimizer 301 analyzes the information to determine which of the two paths 302, 303 to allocate for the data packets. This path allocation analysis is better understood with reference to FIG. 4 shows a diagram 400 of latency versus payload size for both a CPU and with an accelerator in accordance with some embodiments of the present disclosure. Example diagram 400 shows a response curve 401 for CPU processing and a response curve 402 for processing by use of an accelerator. Each curve 401, 402 exemplify the respective latency encountered for a given payload (e.g., data packets) if processed by the CPU only or when allocated to the accelerator for processing. As can be seen in the diagram 400, the use of the accelerator has significant latency advantage for larger payloads. However, at smaller payloads, the CPU provides lower latency. Thus, there is a trade-off of using one or the other (CPU or accelerator processor) for processing data packets, which tradeoff is based primarily on the size of the payload.

Accordingly, the latency optimizer 301 uses this tradeoff between payload size and latency to select a choice of latency for a particular payload size for the data packets. When CPU latency is desired or acceptable, the latency optimizer 301 assigns allocation of the data packets at the L1 level onto path 302 for processing by the CPU 304. When accelerator latency is desired for larger payloads, the latency optimizer 301 allocates the data packets at the L1 level to the accelerator processor 305 for processing. By using the trade-off function shown in diagram 400, the latency optimizer 301 can select which processing (CPU or accelerator) to use based on the payload size.

Note that there is a zone 403 at the lower payload size where the latencies for the CPU and the accelerator are close. Hence, in some embodiments, the latency optimizer 301 can set a selection point based on a threshold that resides in zone 403. For example, a latency threshold point can be set approximately at the intersection 404 where the two curves 401, 402 meet (e.g., the latencies are equal for the given payload). When the payload size is sufficiently small to be below this threshold point, the CPU 304 provides lower latency than the accelerator for processing the data packets. Hence, the processing latency is lower for the CPU 304 than the accelerator processor 305 below the threshold. When the payload size is above the threshold point, the accelerator processor 305 provides lower latency than the CPU 304 for processing the data packets. Hence, the processing latency is lower for the accelerator processor 305 above the threshold.

Accordingly, in some embodiments, the latency optimizer 301 can set the processing latency threshold within the zone 403, either at the intersection 404 where the CPU latency and the accelerator latency are the same, or approximately near the intersection 404 but within the zone 404. For allocation of the data packets to the CPU 304 or the accelerator processor 305 for processing, the latency optimizer 301 analyzes the size of the data packets (or number of data packets) based on the latency-payload relationship, such as of diagram 400. When the processing latency for processing the data packets by the CPU is below the threshold, the data packets are assigned for allocation to the CPU 304 via path 302. When the processing latency for processing the data packets by the CPU 304 is above the processing latency threshold, the data packets are assigned for allocation to the accelerator processor 305 via path 303. It should be noted that the processing latency threshold point based on the intersection 404 may be an estimate

In order to use the latency-payload relationship (e.g., curve 401, 402) to determine the processing latency threshold, the latency optimizer 301 either needs to be given this information or needs to acquire the information. Thus, for some embodiments, at the time of initiating the baseband components (e.g., vDU) as well as the external accelerator, the latency optimizer 301 or the node containing the latency optimizer 301 can run diagnostics to obtain latency measurements for different packet payloads sent to the accelerator processor 305. Generally, this information is available for the CPU 304, but if not, similar diagnostics can be run as well for the CPU 304. This can be done each time a different configuration is deployed in the virtual environment. The measurements can be compiled to produce the curves 401, 402 to obtain the processing latency threshold point within zone 403. A variety of techniques, including machine learning modules, can be used to acquire and tabulate the measurements. It should be noted that the threshold based on the intersection 404 may be an estimate only, since the measurement values may only provide latency-payload comparisons. Hence, setting the threshold within zone 403 allows for estimation for selecting the threshold point.

Furthermore, feedback on latency times for different size data packets sent to the accelerator processor 305 can provide on-going adjustments of the latency-payload curves. The same can be done for the CPU 304 as well. For example, if the latency optimizer 301 obtains feedback that the latency of the CPU has increased, the latency optimizer 301 can readily make adjustments to shift the threshold. This may happen, for example, when too many small payloads are allocated to the CPU based on the threshold setting causing a flow slowdown within the CPU. Adjusting the threshold may then allocate some of those larger payloads to be sent to the accelerator processor 305, instead of to the CPU 304.

Referring back to FIG. 3, once the data packets are processed by the CPU 304 or the accelerator processor 305, the processed data packets could be combined and sent on the same data stream. However, in some embodiments, the two output streams 306, 307 are kept separate. Thus, system 300 shows packet output on path 306 from the CPU 304 and packet output on path 307 from the accelerator processor 305 to the RU 104. Multiple UEs are shown connected to the RU 104. The different sizing of the UEs in FIG. 3 signify different size packet traffic between the UEs and the RU 104. Therefore, for each TTI, smaller payload traffic (UE0 and UE1) can be processed by the CPU 304 if the latency is below the set threshold. Alternatively, for each TTI, larger payload traffic (UE2 and UE3) can be processed by the accelerator processor 305 if the latency is above the threshold. This technique results in creating two data flows, one that consists of very small payloads that can be easily sent to the radio with low latency, while large spectrum allocations can be aggregated and sent to the external accelerator over a second path.

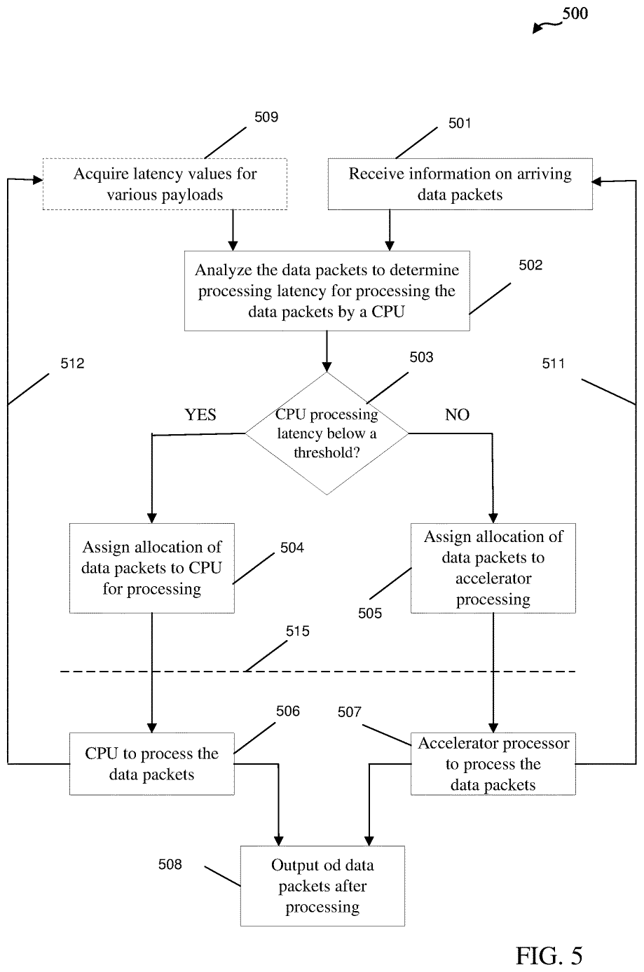

FIG. 5 shows a flow diagram for a method 500 performed by an optimizer to improve processing latency in accordance with some embodiments of the present disclosure. The flow diagram 500 is better understood when taken in context with the description in reference to FIGS. 1-4. The blocks shown above the dotted line 515 pertain to the operation of the latency optimizer 301. The portion shown below the dotted line 515 pertains to operations by the CPU and the accelerator processor. The latency optimizer 301 may reside at a baseband node, such as the cloud deployed vDU 103, or at some other network node. In some embodiments, the latency optimizer 301 operates as a stand-alone unit or the latency optimizer 301 operates as a module for a processor, such as the CPU 304 described herein.

At operation 501, the latency optimizer 301 receives information on arriving data packets. In some embodiments, the information is obtained from the L2 MAC. In some embodiments, the information can be obtained from other sources. In some embodiments, the latency optimizer 301 could receive the data packets themselves and generate the information. The information obtained pertains to a number or size of the data packets (e.g., payload). The information obtained could also relate to a type of data packets or latency sensitivity associated with the data packets. In some embodiments the information on the arriving data packets is obtained for a Transmission Time Interval based on a number of Code Blocks at the Layer 2 level.

At operation 502, the latency optimizer 301 analyzes the information to classify the data packets to determine processing latency for processing the data packets by a central processing unit (CPU). The classifying of the data packets may consider the type of data packets, where the latency optimizer 301 subjects only certain types of data packets to the CPU/accelerator processing analysis. For example, PDSCH, PUSCH, SRS and BFW shown in FIG. 1 can be examples of such data types. Thus, for example, where certain types of data packets are always known to be small, such data packets can always be allocated to the CPU without further analysis by the latency optimizer 301. For those data packets to undergo the latency-payload trade-off analysis to determine the path 302 or 303 for processing the data packets, the latency optimizer 301 analyzes the data packets based on criteria derived from latency versus payload measurements made earlier to obtain the latency-payload curves, such as that shown in diagram 400.

In some embodiments, the latency optimizer 301 analyzes the payload size (e.g., number or size) of the data packets to correlate a latency point for the CPU. That is, what is the latency if the CPU processes that payload. The latency optimizer 301 compares the latency value associated with the CPU for that payload at operation 503. When the processing latency for processing the data packets by the CPU is below a processing latency threshold, the latency optimizer 301 assigns allocation of the data packets to the CPU for processing the data packets at operation 504. However, when the processing latency for processing the data packets by the CPU is above the processing latency threshold, the latency optimizer 301 assigns the allocation of the data packets to an accelerator processor for processing the data packets at operation 505.

In some instances, the processing latency threshold is determined at a point where an estimated latency for processing the data packets at the CPU approximately equals an estimated latency for processing the data packets by sending the data packets to the accelerator processor.

In some instances the analyzing the information on the arriving data packets is performed at a virtual Distributed Unit (vDU) of a baseband node of a wireless communications network, in which at least the accelerator processor is deployed as a Virtual Network Function separate from the CPU. In some instances, the vDU is a virtual node in a cloud Radio Access Network or Open-Radio Access Network of the wireless communications network.

Operation 509 exemplifies the acquiring and usage of latency values for various payload sizes for the CPU 304 and/or the accelerator processor 305. Typically, the CPU latency information is known when the latency optimizer 301 is part of the CPU (e.g., a module of the CPU). The latency information for the deployed accelerator can be acquired externally or, alternatively, acquired by performing measurements on packet throughput. Once the latency-payload curves are available, the latency optimizer 301 can set the threshold point somewhere in the zone 403 to set the switch point between CPU processing and processing by an accelerator processor. Thus, in some instances, an operation compares the latency times for processing by the CPU and processing when sent to the accelerator processor to determine an approximate intersection point where the latency times for the CPU and the latency times for the accelerator processor are equal to set the processing latency threshold.

At operation 506, when the latency optimizer 301 assigns the allocation of the data packets to the CPU 304, the CPU 304 processes the data packets. At operation 507, when the latency optimizer 301 assigns the allocation of the data packets to the accelerator processor 305, the accelerator processor 305 processes the data packets. At operation 508, the outputs of the CPU 304 and the accelerator processor 305 are sent to the destination, such as RU 104, on respective paths 306, 307. In some embodiments the two output are combined. In some embodiments, the two outputs maintain their separation. In some instances, the data packet output of the CPU and data packet output of the accelerator processor are processed at a Layer 1 level.

Method 500 also shows a feedback 511 from the accelerator processor back to the block exemplifying operation 509. The feedback, when used, can provide information on operational parameters for the accelerator processor when those parameters change. The feedback information can be used to modify the latency-payload curve for the accelerator processor, which could change the threshold point. Thus, feedback of latency times of respective different number or size of data blocks can be used to adjust the processing latency threshold. A similar feedback 512 can be used for the CPU as well, in the event the latency optimizer 301 is separate from the CPU.

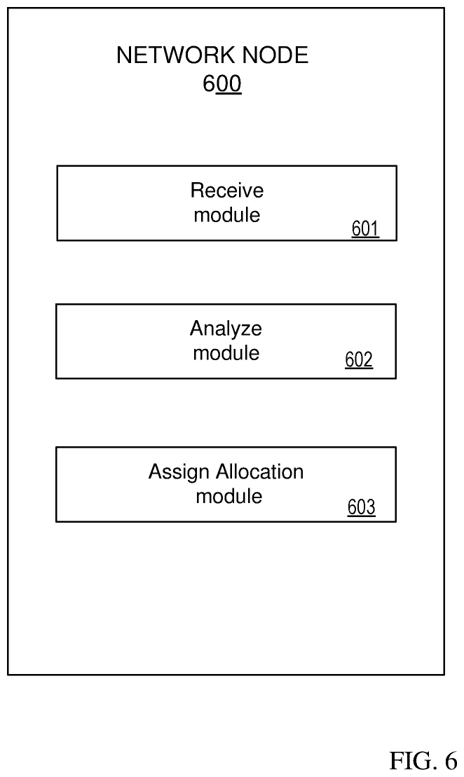

FIG. 6 shows a network node 600 containing an optimizer to improve processing latency in accordance with some embodiments of the present disclosure. In some embodiments, the network node 600 is the above described vDU 103. In some embodiments, the network node 600 is another network node that employs an external accelerator. The network node 600 can implement the functions of the method 500 of FIG. 5, as well as the various embodiments described in the disclosure. As shown, a Receive module 601 can perform operations corresponding to the operation 501 of FIG. 5. An Analyze module 602 can perform operations corresponding to the operations 502 and 503. An Assign Allocation module 603 can perform operations corresponding to the operations 504 and 505.

In some embodiments, the modules 601-603 can be provided as a computer program product, or software, that can include a machine-readable medium having stored thereon instructions, which can be used to program a computer system (or other electronic device) to perform a process according to the present disclosure. A machine-readable medium includes any mechanism for storing information in a form readable by a machine (e.g., a computer). In some embodiments, a machine-readable (e.g., computer-readable) medium includes a machine (e.g., a computer) readable storage medium such as a read only memory (“ROM”), random access memory (“RAM”), magnetic disk storage media, optical storage media, flash memory components, etc.

In some embodiment, the modules of the network node 600 are implemented in software. In other embodiments, the modules of the network node 600 are implemented in hardware. In further embodiments, the modules of the network node 600 are implemented in a combination of hardware and software. In some embodiments, the computer program can be provided on a carrier, where the carrier is one of an electronic signal, optical signal, radio signal or computer storage medium.

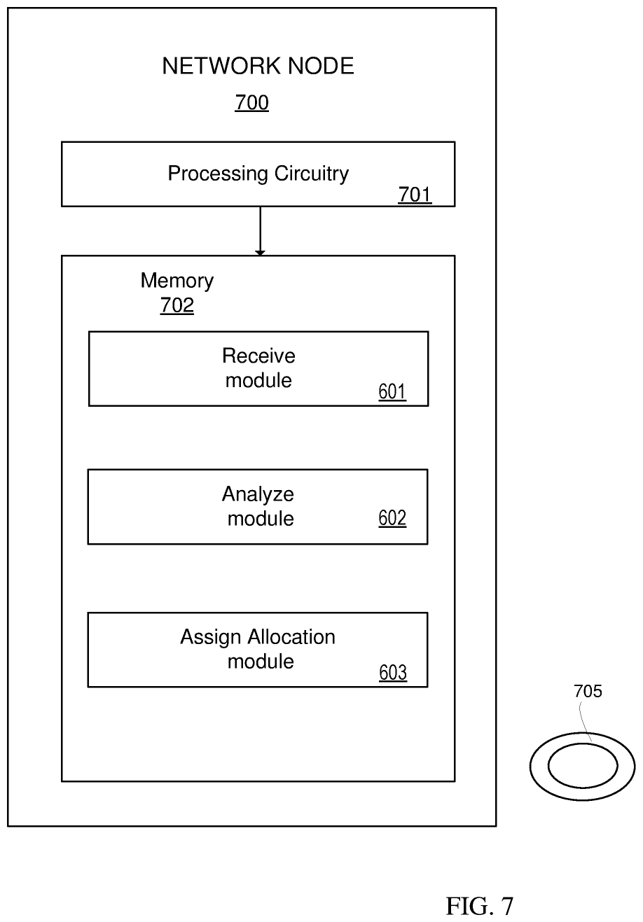

FIG. 7 shows a network node 700 containing an optimizer to improve processing latency in accordance with some embodiments of the present disclosure. In some embodiments, the network node 700 is the above described vDU 103. In some embodiments, the network node 700 is another network node that employs an external accelerator. The network node 700 can implement the functions of the method 500 of FIG. 5, as well as the various embodiments described in the disclosure. In some embodiments, the network node 700 can be configured to implement the modules 601-603 of FIG. 6, wherein the instructions of the computer program for providing the functions of modules 601-603 reside in a memory 702.

The node containing the latency optimizer comprises processing circuitry (such as one or more processors) 701 and a non-transitory machine-readable medium, such as the memory 702. The processing circuitry 701 provides the processing capability. The memory 702 can store instructions which, when executed by the processing circuitry 701, are capable of configuring the network node 700 to perform the methods described in the present disclosure. The memory can be a computer readable storage medium, such as, but not limited to, any type of disk 705 including magnetic disks, optical disks, CD-ROMs, and magnetic-optical disks, read-only memories (ROMs), random access memories (RAMs), EPROMs, EEPROMs, magnetic or optical cards, or any type of media suitable for storing electronic instructions. Furthermore, a carrier containing the computer program instructions can also be one of an electronic signal, optical signal, radio signal or computer storage medium.

In some embodiment, the processing circuitry 701 is part of the CPU, such as CPU 304, when the latency optimizer is part of the CPU. In some embodiments, the processing circuitry 701 is separate from the CPU that processes the data packets.

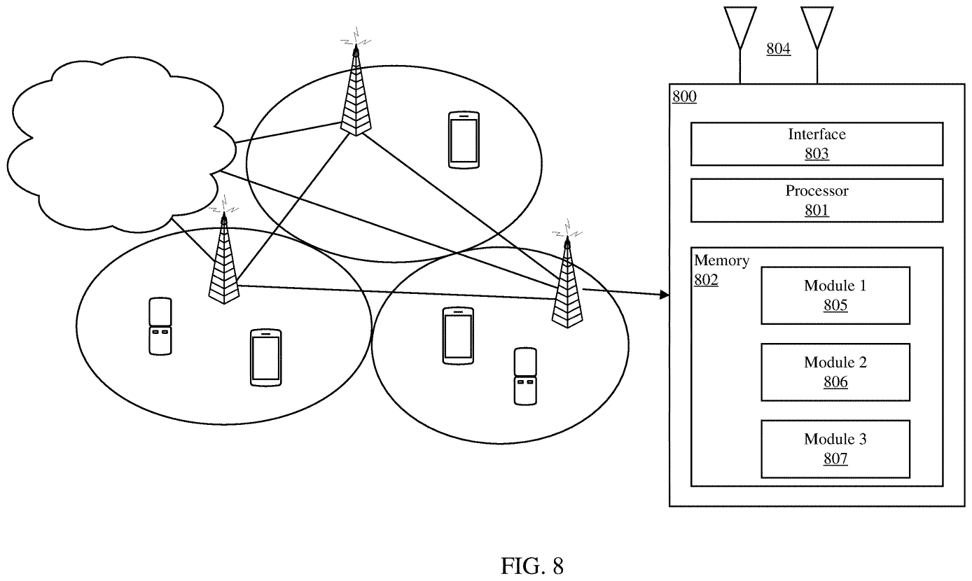

FIG. 8 shows an implementation example for a cloud RAN in accordance with some embodiments of the present disclosure. Network device (ND) 800 may, in some embodiments, be an electronic device that can be communicatively connected to other electronic devices on the network (e.g., other network devices, user equipment devices (UEs), radio base stations, etc.).

In certain embodiments, network device 800 may include radio access features that provide wireless radio network access to other electronic devices (for example a “radio access network device” may refer to such a network device) such as user equipment devices (UEs). For example, network device 800 may be a base station, such as eNodeB in Long Term Evolution (LTE), NodeB in Wideband Code Division Multiple Access (WCDMA) or other types of base stations, as well as a Radio Network Controller (RNC), a Base Station Controller (BSC), gNodeB in 5G, or other types of control nodes. As depicted in FIG. 8, the example network device 800 comprises processor 801, memory 802, interface 803, and antenna 804. These components may work together to provide various network device functionality as disclosed herein.

Processor 801 may be a microprocessor, controller, microcontroller, central processing unit, digital signal processor, application specific integrated circuit, field programmable gate array, any other type of electronic circuitry, or any combination of one or more of the preceding. The processor 801 may comprise one or more processor cores. In particular embodiments, some or all of the functionality described herein as being provided by network device 800 may be implemented by processor 801 executing software instructions, either alone or in conjunction with other network device 800 components, such as memory 802.

Memory 802 may store code (which is composed of software instructions and which is sometimes referred to as computer program code or a computer program) and/or data using non-transitory machine-readable (e.g., computer-readable) media, such as machine-readable storage media (e.g., magnetic disks, optical disks, solid state drives, read only memory (ROM), flash memory devices, phase change memory) and machine-readable transmission media (e.g., electrical, optical, radio, acoustical or other form of propagated signals-such as carrier waves, infrared signals). For instance, memory 802 may comprise non-volatile memory containing code to be executed by processor 801. Modules 805-807 can contain code for executing the operations discussed above in reference to modules 601-603. Where memory 802 is non-volatile, the code and/or data stored therein can persist even when the network device is turned off (when power is removed). In some instances, while network device 800 is turned on that part of the code that is to be executed by the processor(s) 801 may be copied from non-volatile memory into volatile memory (e.g., dynamic random access memory (DRAM), static random access memory (SRAM)) of network device 800.

Interface 803 may be used in the wired and/or wireless communication of signaling and/or data to or from network device 800. For example, interface 803 may perform any formatting, coding, or translating to allow network device 800 to send and receive data whether over a wired and/or a wireless connection. In some embodiments, interface 803 may comprise radio circuitry capable of receiving data from other devices in the network over a wireless connection and/or sending data out to other devices via a wireless connection. This radio circuitry may include transmitter(s), receiver(s), and/or transceiver(s) suitable for radiofrequency communication. The radio circuitry may convert digital data into a radio signal having the appropriate parameters (e.g., frequency, timing, channel, bandwidth, etc.). The radio signal may then be transmitted via antennas 804 to the appropriate recipient(s). In some embodiments, interface 803 may comprise network interface controller(s) (NICs), also known as a network interface card, network adapter, local area network (LAN) adapter or physical network interface. The NIC(s) may facilitate connecting the network device 800 to other devices allowing them to communicate via wire through plugging in a cable to a physical port connected to a NIC. As explained above, in particular embodiments, processor 801 may represent part of interface 803, and some or all of the functionality described as being provided by interface 803 may be provided more specifically by processor 801.

The components of network device 800 are each depicted as separate boxes located within a single larger box for reasons of simplicity in describing certain aspects and features of network device 800 disclosed herein. In practice however, one or more of the components illustrated in the example network device 800 may comprise multiple different physical elements (e.g., interface 803 may comprise terminals for coupling wires for a wired connection and a radio transceiver for a wireless connection).

The solution described herein may be implemented in the network device 800 by means of a computer program comprising instructions which, when executed on at least one processor, cause the at least one processor to carry out the actions according to any of the above features and embodiments, where appropriate. While the modules 805-807 are illustrated as being implemented in software stored in memory 802, other embodiments implement part or all of each of these modules in hardware.

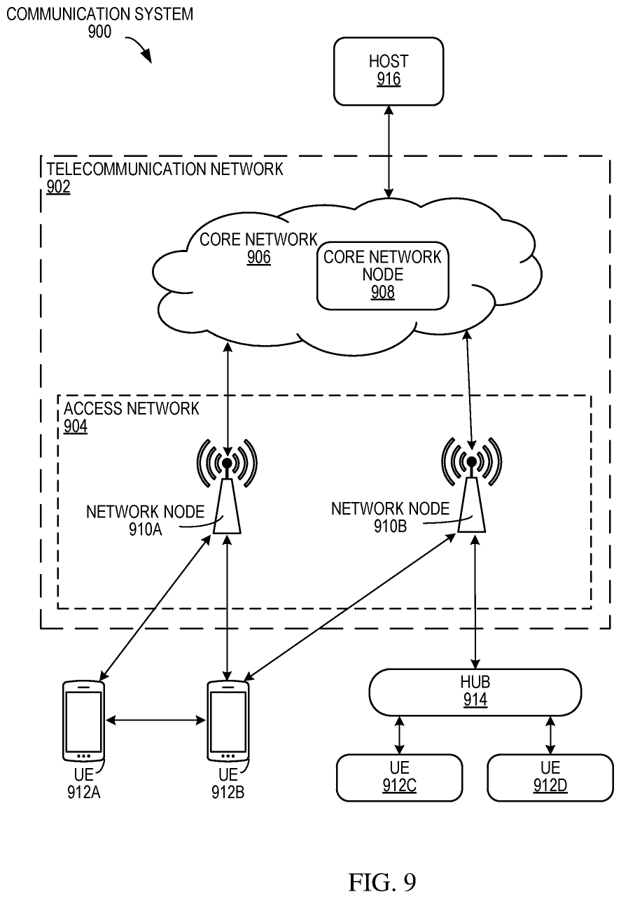

FIG. 9 shows an implementation example for an Open RAN (ORAN) in accordance with some embodiments of the present disclosure. In the example, the communication system 900 includes a telecommunication network 902 that includes an access network 904, such as a radio access network (RAN), and a core network 906 (such as 5GC), which includes one or more core network nodes 908. In some instances, a host 916 connects to the telecommunication network 902. The access network 904 includes one or more access network nodes, such as network nodes 910a and 910b (one or more of which may be generally referred to as network nodes 910), or any other similar 3GPP access nodes or non-3GPP access points. Moreover, as will be appreciated by those of skill in the art, a network node is not necessarily limited to an implementation in which a radio portion and a baseband portion are supplied and integrated by a single vendor. Thus, it will be understood that network nodes include disaggregated implementations or portions thereof. For example, in some embodiments, the telecommunication network 902 includes one or more Open-RAN (ORAN) network nodes. An ORAN network node is a node in the telecommunication network 902 that supports an ORAN specification (e.g., a specification published by the O-RAN Alliance, or any similar organization) and may operate alone or together with other nodes to implement one or more functionalities of any node in the telecommunication network 902, including one or more network nodes 910 and/or core network nodes 908.

Examples of an ORAN network node include an open radio unit (O-RU), an open distributed unit (O-DU), an open central unit (O-CU), including an O-CU control plane (O-CU-CP) or an O-CU user plane (O-CU-UP), a RAN intelligent controller (near-real time or non-real time) hosting software or software plug-ins, such as a near-real time control application (e.g., xApp) or a non-real time control application (e.g., rApp), or any combination thereof (the adjective “open” designating support of an ORAN specification). The network node may support a specification by, for example, supporting an interface defined by the ORAN specification, such as an A1, F1, W1, E1, E2, X2, Xn interface, an open fronthaul user plane interface, or an open fronthaul management plane interface. Moreover, an ORAN access node may be a logical node in a physical node. Furthermore, an ORAN network node may be implemented in a virtualization environment (described further below) in which one or more network functions are virtualized. For example, the virtualization environment may include an O-Cloud computing platform orchestrated by a Service Management and Orchestration Framework via an O-2 interface defined by the O-RAN Alliance or comparable technologies. The network nodes 910 facilitate direct or indirect connection of user equipment (UE), such as by connecting UEs 912A, 912B, 912C, and 912D (one or more of which may be generally referred to as UEs 912) to the core network 906 over one or more wireless connections. Sometime a hub 914 is employed to connect a network node to a UE.

Exemplary embodiments herein have been described above with reference to block diagrams and flowchart illustrations of methods and apparatuses. It will be understood that each block of the block diagrams and flowchart illustrations, and combinations of blocks in the block diagrams and flowchart illustrations, respectively, can be implemented by various means including computer program instructions. These computer program instructions may be loaded onto a general purpose computer, special purpose computer, or other programmable data processing apparatus to produce a machine, such that the instructions which execute on the computer or other programmable data processing apparatus create means for implementing the functions specified in the flowchart block or blocks.

Furthermore, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the subject matter described herein, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

1. A method for optimizing processing of data packets based on latency, the method comprising:
receiving information on arriving data packets;
analyzing the information on arriving data packets to classify the data packets to determine processing latency for processing the data packets by a central processing unit (CPU);
when the processing latency for processing the data packets by the CPU is below a processing latency threshold assigning allocation of the data packets to the CPU for processing the data packets; and
when the processing latency for processing the data packets by the CPU is above the processing latency threshold assigning the allocation of the data packets to an accelerator processor for processing the data packets.

2. The method of claim 1, wherein the analyzing the information on the arriving data packets comprises analyzing a number or size of the data packets.

3. The method of claim 1, wherein the processing latency threshold is determined at a point where an estimated latency for processing the data packets at the CPU approximately equals an estimated latency for processing the data packets by sending the data packets to the accelerator processor.

4. The method of claim 1 further comprising:
acquiring information to determine latency times for respective different number or size of data packets for processing by the CPU and for processing when sent to the accelerator processor; and
comparing the latency times for processing by the CPU and processing when sent to the accelerator processor to determine an approximate intersection point where the latency times for the CPU and the latency times for the accelerator processor are equal to set the processing latency threshold.

5. The method of claim 4, further comprising obtaining feedback on latency times of the respective different number or size of data packets to adjust the processing latency threshold.

6. The method of claim 1, wherein the analyzing the information on the arriving data packets further comprises analyzing a type of data packet to determine whether the data packets is of a selected type to be subjected to determine the processing latency for processing the data packets.

7. The method of claim 1, wherein the analyzing the information on the arriving data packets is performed at a Layer 2 level

8. The method of claim 7, wherein the analyzing the information on the arriving data packets is performed for a Transmission Time Interval based on a number of Code Blocks at the Layer 2 level.

9. The method of claim 1, wherein data packet output of the CPU and data packet output of the accelerator processor are processed at a Layer 1 level.

10. The method of claim 1, wherein the analyzing the information on the arriving data packets is performed at a virtual Distributed Unit (vDU) of a baseband node of a wireless communications network, in which at least the accelerator processor is deployed as a Virtual Network Function separate from the CPU.

11. The method of claim 10, wherein the vDU is a virtual node in a cloud Radio Access Network, or Open-Radio Access Network of the wireless communications network.

12. A network node for optimizing processing of data packets based on latency, the network node configured to:
receive information on arriving data packets;
analyze the information on arriving data packets to classify the data packets to determine processing latency to process the data packets by a central processing unit (CPU);
when the processing latency for processing the data packets by the CPU is below a processing latency threshold assign, allocation of the data packets to the CPU to process the data packets; and
when the processing latency to process the data packets by the CPU is above the processing latency threshold, assign the allocation of the data packets to an accelerator processor to process the data packets.

13. The network node of claim 12, wherein to analyze the information on the arriving data packets comprises analysis of a number or size of the data packets.

14. The network node of claim 12, wherein the processing latency threshold is determined at a point where an estimated latency to process the data packets at the CPU approximately equals an estimated latency to process the data packets when sending the data packets to the accelerator processor.

15. The network node of claim 12 further configured to:
acquire information to determine latency times for respective different number or size of data packets to process by the CPU and to process when sent to the accelerator processor; and
compare the latency times to process by the CPU and to process when sent to the accelerator processor to determine an approximate intersection point where the latency times for the CPU and the latency times for the accelerator processor are equal to set the processing latency threshold.

16. The network node of claim 15, further configured to obtain feedback, on latency times of the respective different number or size of data packets to adjust the processing latency threshold.

17. The network node of claim 12, wherein to analyze the information on the arriving data packets further comprises to analyze a type of data packet to determine whether the data packets is of a selected type to be subjected to determine the processing latency to process the data packets.

18. The network node of claim 12, wherein to analyze the information on the arriving data packets is performed at a Layer 2 level.

19. The network node of claim 18, wherein to analyze the information on the arriving data packets is performed for a Transmission Time Interval based on a number of Code Blocks at the Layer 2 level.

20-22. (canceled)

23. A non-transitory computer-readable storage medium comprising instructions which, when executed on at least one processor cause the at least one processor perform operations for optimizing processing of data packets based on latency comprising:
receiving information on arriving data packets;
analyzing the information on arriving data packets to classify the data packets to determine processing latency for processing the data packets by a central processing unit (CPU);
when the processing latency for processing the data packets by the CPU is below a processing latency threshold, assigning allocation of the data packets to the CPU for processing the data packets; and
when the processing latency for processing the data packets by the CPU is above the processing latency threshold, assigning the allocation of the data packets to an accelerator processor for processing the data packets.

24. (canceled)
